(19) United States
(12) Patent Application Publication
(10) Pub. No.: US 2007/0236613 A1
(43) Pub. Date: Oct. 11, 2007

(54) TV remote with image capability

(76) Inventor: Jonathan G. Foss, Shorewood, MN (US)

Correspondence Address: Mark A. Litman & Associates;Suite 205, 3209 West 76th St., York Business Center, Edina, MN, 55435, US

(21) Appl. No.: 11/391,513

(22) Filed: Mar. 28, 2006

(51) Int. Cl. H04N 5/44

(52) U.S. Cl. 348/734

(57) ABSTRACT

A hand-held remote control device has a viewing screen that displays information, possibly including real time information available through reception in the television or reception available to the television. The remote control displays the information, which may be different than the information actually displayed on the television, including available menus and images of channels other than a channel being viewed on the television. The remote may switch functions among view only on the remote, control television only, or combinations of image/volume control on the television at the same time that remote viewing is enabled.

### BACKGROUND OF THE INVENTION

1. Field of the Invention

The present invention relates to a peripheral device or accessory unit for a television set, or a fixed viewing device, monitor, home theater projector, comprising a remote control device which may be supported by an interface from which the television, radio or data stream, signal is broadcast or from which a signal can be tapped. The present technology also relates to a hand held, or mounted (e.g., on treadmills for example), remote control that also comprises a view screen and receiver component that cooperates and transmits with the peripheral device. The technology also relates to a corresponding television system having a peripheral device and a receiver device.

2. Background of the Art

The use of the remote television control has become almost universal since its initial introduction in the 1950s. The initial remote control devices were fairly simple devices that enabled a viewer to change channels, control volumes, and most importantly with early color television sets, to control the hue and balance of the set, which often shifted when channels were changed. On-off control was also available, but channel movement was initially only up and down through the available sequence of channels. The modern television viewing system, and correspondingly the remote control system is far more complex and offers a much wider array of channels and options. The remote enables all ordinary television control, but may also be a universal system that enables control of cable boxes or cable access, VHS control (including record functions), DVD controls, cable guides, movie purchase, program orders, on-line product purchases and the like.

With all of the functional capability available on the remote control systems, there has been a continuing social problem in the use of the remote control is competition for its use and the desire to view alternative channels without interrupting the viewing pleasure of others watching the television. It is annoying to try and watch a channel while someone else constantly changes channels while surfing for an alternative viewing option. Also there is a continuing and increasing desire to have portable programming, to download and watch at later moment and/or location. In addition there is a growing desire to share content with others, such as pictures, movies and data files with others.

Published US Patent Application No. 2006/0037045 describes a system for previewing and switching to favorite channels is employed to divide a screen such as a TV screen into a main window and a plurality of sub-windows to display contents of programs of different channels. The sub-windows are used to display the contents of preset favorite channels, while the main window is used to display a content of a program of a current channel. The system includes a tuner, a decoder, an audio processor, an SOC, an EEPROM, a speaker, a display, a remote controller and an infrared receiver. The SOC respectively connects with the tuner, the decoder, the audio processor, the EPROM, the display and the infrared receiver.

Published US Patent Application No. 2006/0031881 describes a method for displaying an electronic program guide (EPG) to a viewer. The method includes displaying one or more data slices representative of broadcast programming to a viewer. In response to input from the viewer, the displayed number of data slices is increased, for example, from one slice to two slices. In browser mode the viewer can scroll through multiple EPG data slices without selecting to view full mode EPG, while in full mode the EPG can expand from a single column of data slices to multiple columns of data slices based upon viewer selections. The EPGs of the present invention can display programming that a viewer is more likely to watch at a particular time than other programming. A data slice representing the predicted programming can be inserted into the EPG so that the viewer can identify programming that is likely to be of interest.

One attempt to address such a problem is shown in Published US Patent Application 2006/0028582 (Zahn) teaches a parallel, nearly simultaneous transmission channel that simulates real-time interactive capability from a television station to a viewer in a peripheral device for a television set including an interface at which the television signal can be picked up. The peripheral device is provided with a plug-in device for connecting the peripheral device to the interface of the television set or an additional interface that is connected to the television set. At least one portion of the television signal applied to the one interface or the additional interface is processed by a processing device of the peripheral device while the data supplied by the processing device is transmitted to a receiver unit via a transmitter unit of the peripheral device.

### SUMMARY OF THE INVENTION

A hand-held remote control device has a viewing screen that displays information, possibly including real time information available through reception in the television or reception available to the television. The remote control displays the information, which may be different than the information actually displayed on the television, including available menus and images of channels other than a channel being viewed on the television.

The remote may switch functions among view only on the remote, control television only, or combinations of image/volume control on the television at the same time that remote viewing is enabled.

The device does not need to be in the room, just within the limits of reception, this will come in handy if you need to be absent from the room for a period of time (as when taking a restroom break). one format of the device, its hard drive, memory sticks, chips etc. can be brought to other televisions and projection devices, and the device may download or upload. This will come in handy to show travel pictures to others on their set. This remote may also be able to show and interact with, additional alpha signals, (which is the layered menu that is at the beginning of a DVD menu.) Touching the screen will activate this. For example, “play all scenes” on a DVD menu, or “send me info on Pontiac cars.” When the remote device is out of range, it may operate on saved data only.

### BRIEF DESCRIPTION OF THE FIGURES

FIG. 1 shows a schematic diagram of a system within the scope of the disclosure.

FIG. 2 shows a hand-held device according to the present disclosure.

### DETAILED DESCRIPTION OF THE INVENTION

The present technology provides an optional, parallel and nearly simultaneous transmission channel simulating a real-time interactive capability from the television transmitter to a television remote control with a separate viewer function in the remote control unit. The television system must be able to provide a source or access to broadcast in a manner that is also available to the remote. The remote may have access to a plug-in or wireless system, line or device for communicationally connecting the peripheral device to the interface of the television set or a corresponding interface of a further peripheral unit, such as, e.g., a video recorder or cable box, connected to the television set, at least one portion of the television signal present at the one interface or the further interface being processed by a processing device of the peripheral device and the data supplied by the processing device being transmitted to a receiver component in the remote control via a transmission device on the peripheral device. With Freescale technology (11.2 mHz, per second) coupled with compression technology, virtually all data channels can be beamed and surfed at once. This would allow the remote to show more than one channel at a time, in windows for example.

A particular advantage of the present technology that the transmission or communication and display of the program-accompanying additional data on the remote control does not disturb or impair the television picture.

The processing device may extract impressed additional data in addition to the program signal from the television signal and condition them for the transmission to the remote control hand-held device. This extraction generally may comprise the decoding, compression, encryption, or decompression and, if appropriate, the partial decryption of the additional data. The conditioning may comprise the renewed coding for the transmission to the receiver device.

It is also possible for multiple hand-held remote control devices to operate off the feed from the television system and any peripherals that are part of the system. The individuals in the room may have their individual unit with a wide area feed or with individual direct connection to the television, cable or peripheral.

The transmission of the data by the transmission device is not exclusively unidirectional and may be effected essentially simultaneously with the broadcast program signal to the receiver device. The multidirectional transmission is not with respect to program content, as that signal is widely broadcast between the television and the remote, but the remote does communicate with the television, cable or auxiliary (VHS, DVD, thumb drive, flash drive, ipod, CD, hard drive or any future possible media storage device etc.

In one embodiment variant, the peripheral device may have a socket or seating device in which at least one further peripheral unit for the television set can be connected, the peripheral device being essentially transparent between plug-in and socket device. In one case, the further peripheral device is a video recorder, cable box, rabbit, DVD player or the like. The interface of the television set is not blocked for other applications by the use of the peripheral device according to the invention.

Furthermore, it is preferred for the peripheral device to be formed as a plug-in module with a plug section and a socket section. The connection of the peripheral device according to the invention is made possible simply and reliably without any further space requirement through simple insertion of the plug-in module. The peripheral device may draw its the energy for its electrical supply from a portion of the electrical energy of one or more interface signals of the television, other peripheral or television signal. Consequently, the peripheral device does not require a power supply system connection or a battery and the like, but one may be provided, if desired. (This could also be powered by a thin film battery that can be recharge through induction, where you set it on a pad, CYMBET corporation in Elk River has this technology.

In one case, the transmission device is an RF transmitter (alternatively, e.g., IR connection or cable) that transmits the data supplied by the processing device as coded pulses in encrypted or unencrypted form to the receiver device. If the pulse-coded transmission has a correspondingly low duty cycle, it may have low power consumption. The encryption is particularly preferred in order to avoid undesirable manipulations and to preclude interception. For example, if the remote asks for channel 17, the peripheral system emits channel 17.

The technology is particularly advantageous in connection with an interface which taps the broad range of information in the feed to the television or the auxiliary components or cable box. The data feed or information can be tapped off the television in parallel, without the television picture being impaired visibly to a user, with the current program. Consequently, it is also possible precisely to communicate additional information assigned to a currently set or tuned channel.

Any further peripheral or accessory unit that cooperates with the peripheral device or plug-in module according to the invention is preferably a receiver device having a reception capability for data transmitted by the peripheral device, but under certain circumstances also having further transmission capabilities, e.g., to the peripheral device or for remote data transmission, the further peripheral or accessory device or the receiver device preferably being a portable unit comprising a display device for displaying data, an input device for inputting data and a processing device.

The device’ connection to the internet through WiFi, wireless, USB, phone lines, Bluetooth or cable will allow it to download data that can operate, multiple devices.

But in this case the device would beam or otherwise direct a signal to a television and could learn the code from the peripheral device. Then the device will be able to go to the internet and get the codes to talk to the peripheral device. This provides a self learning driver download capacity.

To simulate an interactive capability, it is preferred for the processing device of the peripheral device to extract from the television signal data which have two different sets of data, individual data of the two data sets being assigned to one another, assigned data of the two data sets being transmitted to the receiver device by the transmission device, and at least initially any data of the first data set being displayed on the display device of the receiver device, and the second group of data being used for the evaluation of data input by a user via the input device of the receiver device by the processing device of the receiver device. A unique attribute of the system is the fact that the full bandwidth of image information, as well as any textural information (e.g., menus, program titles, synopses, future hyperlinks, such as interactive voting or question answering through the Tv, vote in on if a person is guilty, or if you are interested in a product placement item and get info. etc.) is available to the remote control. No other system is known to provide the image stream to a remote device in a remote controller.

The receiver device may even have a loudspeaker or headphone port via which data generated by the processing device are remotely transmitted. It may be desirable require input of an authentication code in the manner of a mobile telephone in order to prevent unauthorized operation of the receiver device. Also the peripheral device can send an audio signal to head phones.

Furthermore, the present invention relates to a plug-in module which can be inserted into an interface of a television set or into an interface of a peripheral unit connected thereto, the inserted plug-in module having a device for separating additional data impressed on the television signal present at the interface from said television signal, and the plug-in module furthermore having a transmission device for transmitting the additional data to a portable receiver device. In this case, a plug-in module denotes a structural unit that can be fixed to the interface by means of a simple plug-in operation and has a corresponding plug part for this purpose. Examples of corresponding peripheral devices are for instance a video recorder, a set-top box and the like. The preferably program-accompanying additional data are impressed on the program signal at the transmitter end, and transmitted in the blanking interval, for example, together with the television signal. The receiver device is portable and can be carried by a user. This may be another form or use of an alpha channel.

The invention and also further features, aims, advantages and application examples thereof are explained in additional detail with reference to the accompanying drawings. Throughout the drawings the same reference symbols designate the same or corresponding elements. In this case, all features that are described and/or represented pictorially form the subject matter of the present invention by themselves or in any desired expedient combination, to be precise independently of their combination in the patent claims or the reference back thereof.

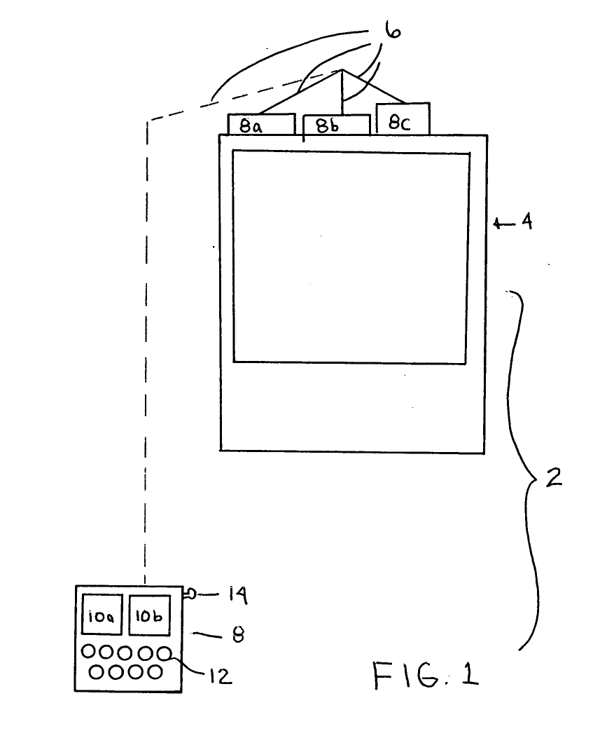

FIG. 1 provides a schematic overview. The illustration reveals a system 2 preferably comprising a domestic TV receiving unit or television 4 which can receive TV signals by various methods, such as broadcast, cablecast, satellite or the like. Various transmission paths to the various components are shown as paths 6 to the television and are indicated schematically in FIG. 1. The remote system 8 is shown with one communication path 6a to the three components 8a 8b and 8c, which may be by way of a non-limiting example a Cable box 8a, DVD/VHS player 8b or a special auxiliary communication/decoding device 8c. The remote handheld device 12 is shown with two screens 10a 10b, which may be operated at the same time or one-at-a-time, as for different channels, different content (image and text), or for communication independent of the TV remote system (e.g., internet access). If not touchscreen control is provided, which might be limited in utility because of the small screens, a control panel or keyboard panel 12 may be provided and/or a mouse control 14. More precisely, TV reception via satellite, terrestrial TV reception and TV reception via a cable network are shown. These transmission paths can be used either individually or in combination in connection with the present technology. The TV signals are broadcast by a television, satellite or cable transmitter on the different transmission paths. Additional data impressed on the television signal may be transmitted together with the television signal to the television set.

A number of techniques are known for this purpose in the prior art without the viewable remote system, including at least PCT publication WO 02/25924 A2, the entire disclosure of which is incorporated by reference, as is every application or patent cited herein. According to the described method, the additional data are not incorporated in the blanking interval, which is the case for instance for conventional teletext, but rather in the video signal, that is to say in that part of the television signal which is displayed on the television set, in a manner not visible to the television viewer.

Various television standards are known in the prior art. Quite generally, a television signal is composed in particular of an actual video signal (V), the blanking signal (B), and the sync signal (S). In this case, the video signal has the information obtained line by line about the brightness distribution of a picture original to be transmitted. During the horizontal and vertical beam flyback, the video signal is interrupted in its temporal progression; it is as it were “blanked”. The blanking signal is formed by line-frequency horizontal blanking pulses and by vertical blanking pulses which appear with the rhythm of the field change and have a shorter duration than the horizontal blanking pulses. In order, at the receiving end, to enable the line raster written on the television picture tube to proceed synchronously with the line raster at the transmitting end, the sync signal is provided. It equally controls the deflection devices at the recording and reproduction converter. In addition, a chrominance signal is also transmitted in order to permit a compatible color picture transmission. For transmitting the accompanying sound, a frequency modulation of a high-frequency sound carrier oscillation is usually used in television broadcasting.

The television transmission that is known in accordance with the prior art takes up a broad and costly communication channel, but the latter is not fully utilized. For approximately a quarter of the transmission time no actual picture information, corresponding to the video signal defined above, is transmitted. The synchronizing information for the horizontal and vertical beam deflection is transmitted in the periodically occurring blanking intervals. Nevertheless, e.g., according to the CIR 625-line standard, 17 full lines which could be occupied by additional information still remain per field. However, in accordance with the prior art, only approximately twelve lines per field are occupied by test and data signals. This transmission of additional test and/or data signals is not manifested to the television viewer in a disturbing manner because they lie within the vertical blanking.

One example of a data signal of this type is teletext. Teletext affords a television subscriber the possibility of perceiving, in addition to the television program offered, information from particular areas by means of characters and graphics on the screen. The editorial conditioning is performed by the broadcasting corporations and institutions appointed by them. Examples of what is offered include current news, traffic indications, weather reports, sport information and the like. However, insertions in the current program such as, e.g., subtitles in the case of foreign language broadcasts, may likewise be performed as well. This may still be used in the HDTV format?

The method published in the PCT publication WO 02/25924 A2 is based on the central idea that a multiplicity of lines per field cannot be occupied by data signals for reasons of the tolerance margin. This is due to the fact that every television receiver has a so-called “cache” and thus makes only part of the active video signal visible to the user. Since the size of the cache differs depending on the design of the television set used, these intervals are not used for data transmission, in order not to adversely affect the viewing comfort of the television viewer. The central idea of this previously described method consists, however, precisely in overcoming this prejudice and indeed using these hitherto unused intervals for data transmission. The case in which picture reproduction is impaired for a television receiver with a correspondingly large cache is taken into account by the fact that the transmitted data are designed to be minimally invasive for the television picture. In an advantageous manner, the data are transmitted in the actual video signal. In this way, the data are concomitantly recorded for any type of recording of the video signal, e.g., by means of a conventional video recorder, and are thus available in particular also during the reproduction of the recording. Therefore, additional information can likewise be supplied to a television viewer about whom one knows as it were that he is currently receiving a specific program signal since the information is transmitted in the picture.

The general practice of the technology of the invention includes at least a remote control device for providing signals or commands to a television set. The remote control device taps or intercepts or separately receives signals from the television or the same signals sent to the television. At least one component of the signal content is selected from the group consisting of video signals and menu lists. The remote control device has a video display area which displays the at least one signal content without altering a display on the television set. The at least one signal is received (e.g., tapped) from at least one of an antenna, a cable line, a satellite dish, the television, a cable box, and a data converter. The remote control device preferably has a wireless communication component in the remote control device that can tap or intercept or receive the same signals that are received by the television and may even receive the signals separately broadcast from the television, cable system, satellite dish system, optical fiber system, wireless system or wired system of any type or nature. The remote control device may have the at least one signal as tapped from at least one of an antenna, a cable line, a satellite dish, the television, a cable box, and a data converter.

The remote control device may have a hard wire connection communication component in the remote control device that can tap or intercept the signals from the television. At least one signal may be tapped from at least one of an antenna, a cable line, a satellite dish, the television, a cable box, and a data converter or any other wired or wireless system, analog or digital, electronic or optical. The remote control device may be in communication with a peripheral device that receives said signals before or as the television receives the signals and forwards the signals to the remote control device. The remote control device may be designed so that the peripheral cannot record or play image data or otherwise designed so that the peripheral can record or play image data.

The remote control device may have the peripheral device positioned in a communication stream to receive the television signals at the same time as or before the television signals are received by at least one component in communication with the television selected from the group consisting of an antenna, a cable line, a satellite dish, the television, a cable box, and a data converter. The peripheral device may be positioned in a communication stream to receive the television signals at the same time as or before the television signals are received by at least one component in communication with the television selected from the group consisting of an antenna, a cable line, a satellite dish, the television, a cable box, and a data converter or any other signal transmission system for video, audio (music channels on cable) or television viewing. This aspect of the technology may also be wireless. For example, the remote control device may have the television signal received by a peripheral device for a television set having a first interface at which the television signal can be tapped off, the peripheral comprising a plug-in device or wireless communication component for providing a communication link between the peripheral device to the first interface of the television set or to a corresponding second interface of a further peripheral unit connected to the television set; a processing device configured to process at least a portion of the television signal present at the first or second interface of the peripheral device; and a transmission device configured to transmit data supplied by the processing device to a receiver device. The peripheral box may also be embedded, especially as long as it is in the stream of data. The processing device may extract impressed additional data in addition to the program signal from the television signal and conditions the impressed additional data for transmission. The processing device may extract from the television signal data having two different sets of data, individual data of the two data sets being assigned to one another, assigned data of the two or more, for example an advertisers data stream of data, data sets being transmitted to the receiver device by the transmission device, and at least initially any data of the first data set being displayed on the display device of the receiver device, the second group of data including evaluation data for evaluating data input into the receiver device by a user. So the consequence of this, in affect this is proposing that a single peripheral device and its processor could run all the remotes and TVs, or video panels in the house.

Referring to FIG. 1 again, the additional data which are preferably impressed on the television picture in the video signal are detected by a peripheral device for a television set, (Although this is not a preference as to where this technology should go, it is desirable to control what a child is watching on a kids show like blues clues, and the child or other user may touch or mouse the remote screen to answer a question, the response could be shown on an overlay video channel, such as “You got this right!” This format is called real time compositing in the video world which is shown as a plug-in module in FIG. 1 and is inserted in the application in a SCART socket on the rear side of the television set, and are transmitted to a preferably portable, handheld receiver device. The SCART socket is particularly preferred in this case since, by this means, the video signal that is currently set on the television set is accessible externally—without disturbing the television set—and the TV tuner of the television set as it were operates for the method according to the invention. A remote control for the television set is preferred as the receiver device, said remote control being learning, that is to say programmable and usable for all types of television sets. The peripheral devices 8a 8b 8c as well can have other main functions, DVD, Video game xbox2, The receiver device may also have other (main) functions, and may be, e.g., a mobile telephone, ipod, GameBoy™ or a PDA or an accessory unit therefore. This is where the downloadable drivers referred to above. Furthermore, the receiver device or remote control has various additional functions which are explained in more detail below and about which it will merely be mentioned at this juncture that the remote control can receive the additional data that are impressed on the video signal and detected by the peripheral device and present them on a display panel or display. Furthermore, the illustration of FIG. 1 reveals that a return channel is also provided, via which data can be sent back to a computing center from the receiver device via the telephone network, in particular the landline network. By means of the computing center, the additional data transmitted to the computing center by a service provider for content management for interactive television (TV) are also sent to the television transmitter for impressing the “video barcode” in the television signal.

The technology of this system may use a SCART connection (SCART=Syndicat Francais de Constructeurs d'Appareils Radio et Television), which is likewise known by the designation “Peritel” or “Euroconnector,” is a multipurpose connection for use with home video equipment. Video, audio and control connections are enabled via a standardized 21-pin connection. With regard to a formal description for this, reference is made to the standards CENELEC EN 50049-1:1989 or IEC 933-1. The plug-in module according to the invention is preferably essentially transparent between plug-in section and socket section. This means that, in particular, the connection of a video recorder to the television set via the SCART connection can continue to be used despite the use of the plug-in module according to the invention. By way of example, pins (including ground) might be through-connected in such an application. It goes without saying that, in other applications, more or all pins may be through-connected between the plug-in section and the socket section. It should be noted that, according to the invention, the plug-in module may also be formed without a socket section. If the plug-in module according to the invention is then connected to a corresponding SCART connection of a television set, the possibility of connecting further peripheral devices, such as a video recorder for example, to the television set via said SCART connection is obviated. The SCART connection of the television set is therefore occupied for the system according to the invention. This is innocuous in many cases, however, for example in a case where the television set is provided with a plurality of SCART connections, so that one of the further SCART connections can simply be used for connecting a video recorder. Likewise, instead of being connected directly to a SCART connection of the television set, the plug-in module according to the invention may also be plugged onto a corresponding SCART connection of a peripheral device that is connected to the television set via the SCART link. By way of example, in an application in which a television set is connected to a video recorder via a SCART link and the video recorder is provided not only with a SCART input but also with a SCART output, the plug-in module according to the invention can be connected to the SCART output of the video recorder since the SCART connection of the television set is looped through via the two SCART connections of the video recorder. Finally, it is also possible for the plug-in module according to the invention to be integrated into the television set as early as during the production of said television set, so that it is no longer necessary for an external plug-in module to be connected in order to implement the system according to the invention. The preferred exemplary embodiment is geared to the SCART interface of the television set, which is preferred because firstly it is very widespread, the television signal currently being displayed on the television set is already present at this interface (pin 19: video output) and, not least, the mechanical properties of the SCART link are virtually predestined for use of a dongle.

With regard to the electronic construction of the plug-in module 1 it should be noted that said plug-in module has a processing device in order to read and separate additional data impressed on the television signal from the currently set channel of the television set. Such additional data can be transmitted for example in the blanking interval in a manner not visible to the television viewer. The additional data may be transmitted together with the television or teletext, for example. Also possible for this purpose are so-called “watermarking” methods, in which additional data are transmitted in the television picture. For this purpose, the processing device may have a microprocessor with a low power consumption, and also diverse memory devices such as, for example, hard drives a RAM and/or a flash memory. The remote could also play DVD's and the delay in signal could be very advantageous because the apparent simultaneous function between the peripheral and remote. An exchangeable battery may be provided, in principle, for the electrical supply of the processing device. However, particular preference is given to a solution which manages without a battery and which draws the energy required for supplying the electrical components from the video output present via pin 19. For this purpose, part of the video signal is tapped off and buffer-stored by means of a capacitor. In this case, use is made of the power taken up from the video output signal preferably only within specific lines of the video frame, for example those teletext lines which have a defined signal level, in order to avoid a black level disturbance of the video signal or some other disturbance which might lead to an impairment of the video recording. In addition to a processing device, the plug-in module according to the invention also has an RF transmitting device. By means of the RF transmitting device, the data read or extracted from the television signal are transmitted to the receiver device 2. Since the electrical power obtained from the video signal is not particularly high, it is preferred for the RF transmitting device to transmit coded pulses to the receiver device. In this case, the “duty cycle” of the transmitted pulses is very low, whereby the requisite power consumption is reduced. In order to prevent an interception of the data transmission from the plug-in module 1 according to the invention to the receiver device 60 according to the invention, the pulses are preferably transmitted in encrypted fashion. The RF transmitting device is preferably operated in one of the free ISM bands (e.g., 868 MHz or 2.4 GHz), bugt any functional wavelength or band may be used.

It should be noted that the system according to the invention is suitable for any type of reception of the television signal, that is to say in particular for terrestrial, digital, High Definition TV and analog reception and also for reception via cable or satellite. With these additional data which are tapped off at the television set, e.g., via the SCART interface or inductively, the method on which the present invention is based can also be carried out without a television transmitter, and the additional data can be transmitted to the receiver device, preferably a remote control, for carrying out prize games, betting, voting, etc.

The receiver device is a compact, portable unit having an RF receiving device, a display device and also an input device. By means of the RF receiving device, the data transmitted by the RF transmitting device of the plug-in module are received and decoded and decrypted by a corresponding processing device. The receiver device furthermore has an internal clock that can be updated by time information transmitted by the plug-in module. Furthermore, the receiver device has a smart card chip in which electronic cash, or else virtual money, as it were electronic “tokens” or “chips,” has been previously stored. Such a smart card chip has the advantage that all security-critical transactions, e.g., excluding the RF reception control and the control of the display device, with regard to the amount stored on the cash chip, proceed in the chip and are therefore largely inaccessible to external manipulation. The peripheral device also has a call button in order to find remote devices that our lost, as well as a sync function that could allow foreign devices, for example someone to ipod to sync. The display device is preferably an LCD display with a minimal line number of seven lines. The receiver device preferably has an exchangeable battery for power supply purposes. The size of the receiver device preferably ranges from the size of a credit card through to the size of a PDA, it can be larger than that, the are remote controls now that are the size of books 40×15 cm and larger is what is used for the visually imp[aired or small children to facilitate their limited motor skills. The receiver device may also be formed as an additional module with respect to a PDA and be connectable thereto.

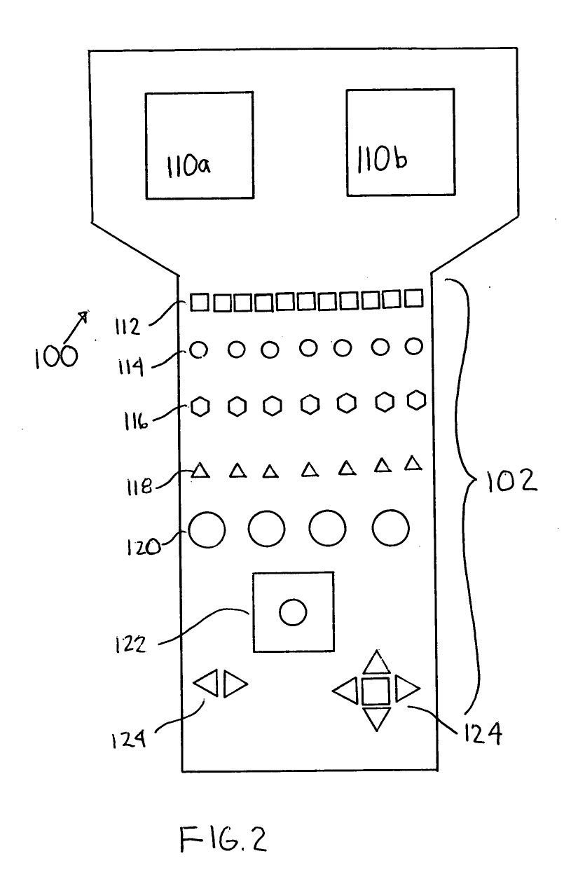

FIG. 2 shows a front view of a remote control element 100 and control panel 102 that may be used according to the present technology. There are two separate viewing panels 110a 110b on the remote 100. The control panel 102 is shown with lines of buttons 112 114 116 118 120 for various purposed, a mouse control 122 and two directional arrays 124 126. The internal workings of the remote are not shown but may use standard IT components and communication links, with memory, microprocessors, display panels, data input, ports, and peripherals as needed. The hardware may also use ASICs, FPGAs, circuits, boards, chips and the like to perform the stated tasks.

Program guide information (e.g., reminder information, listings information, recording information, message information, status information, parental control settings, audio and video, status or polling information, user information, favorites settings, or any other information necessary for remotely providing program guide functionality) may be exchanged, and settings set.

This would be very convenient for TV broadcasters to make sure their audience is watching.

Access communications may include, for example, commands, requests, messages, remote procedure calls (e.g., using a proxy-stub pair), or any other suitable client-server or peer-to-peer communication. Access communications may also involve, for example, complex communications between application constructs running on remote program guide access device and interactive television program guide equipment. Objects running in the two versions of the program guides, for example, may communicate using an Object Request Broker (ORB). The program guide information may, for example, be encapsulated as component object model (COM) objects and persisted to files that are transmitted over remote access link. In another approach, access communications may include HTML formatted markup language documents (e.g., web pages) that are exchanged between remote program guide access device and interactive television program guide equipment via Internet service system. Existing electronic program guides may be viewed in either browser mode or full screen or mode. In browser mode, a viewer can watch substantially all of the available display screen while searching through one or more slices of programming information for programs and services concurrently or subsequently available to the viewer. In full mode, a viewer can search multiple slices of programming information, however, the viewer is typically unable to watch programming concurrently with performing searching activities. To overcome limitations associated with concurrent viewing of programming and electronic program guides and the need to scroll through multiple slices of programming, disclosed herein are systems and methods for providing an expandable browser mode electronic program guide. Further, to overcome other limitations associated with searching electronic program guides, an expandable full mode electronic program guide and a programming guide capable of predicting which program of the available programming that a viewer may wish to watch at a particular time period are disclosed herein. Numerous methods may be provided for displaying an electronic program guide to a viewer while television programming is substantially viewable on the remote hand-held controller by the viewer. The electronic program guide of the present invention may be incorporated within or otherwise used with a special purpose or general purpose computer, including computer hardware as discussed in detail herein. Set-top boxes that enhance the capabilities of conventional televisions represent an example of one type of special purpose computer that may benefit from the electronic program guide of one embodiment of the present invention.

Other embodiments may include multiple computers, whether special purpose or general purpose, that are linked in a networked environment, as understood by one skilled in the art in light of the teaching contained herein.

Other general considerations that are at least partially addressed herein but which may also be combined with the underlying technology along with the TV remote system includes touchscreens and that people could have the ability to jump out of the program and go to a website. A surf channel could be provided which would allow the user to surf on the TV as you would conventionally, but the TV program would continue on the remote. This would enable a user to know when to switch back after a commercial or to an important period in another channel. Additionally if watching a commercial, the user may click on it and the TV displays the web-site and the show continues on the remote with an advertising display, such as “Join my health club!”

What is claimed:

1. A remote control device for providing signals or commands to a television set, the remote control device tapping or intercepting signals from the television with at least one signal content selected from the group consisting of video signals and menu lists, the remote control device having a video display area which displays the at least one signal content without altering a display on the television set.

2. The remote control device of claim 1 wherein the at least one signal is tapped from at least one of an antenna, a cable line, a satellite dish, the television, a cable box, and a data converter.

3. The remote control device of claim 1 wherein there is a wireless communication component in the remote control device that can tap or intercept the signals from the television.

4. The remote control device of claim 3 wherein the at least one signal is tapped from at least one of an antenna, a cable line, a satellite dish, the television, a cable box, and a data converter.

5. The remote control device of claim 1 wherein there is a hard wire connection communication component in the remote control device that can tap or intercept the signals from the television.

6. The remote control device of claim 5 wherein the at least one signal is tapped from at least one of an antenna, a cable line, a satellite dish, the television, a cable box, and a data converter.

7. The remote control device of claim 1 wherein the remote control device is in communication with a peripheral device that receives said signals before or as the television receives the signals and forwards the signals to the remote control device.

8. The remote control device of claim 7 wherein the peripheral cannot record or play image data.

9. The remote control device of claim 7 wherein the peripheral can record or play image data.

10. The remote control device of claim 7 wherein the peripheral device is positioned in a communication stream to receive the television signals at the same time as or before the television signals are received by at least one component in communication with the television selected from the group consisting of an antenna, a cable line, a satellite dish, the television, a cable box, and a data converter.

11. The remote control device of claim 8 wherein the peripheral device is positioned in a communication stream to receive the television signals at the same time as or before the television signals are received by at least one component in communication with the television selected from the group consisting of an antenna, a cable line, a satellite dish, the television, a cable box, and a data converter.

12. The remote control device of claim 1 wherein the television signal is received by a peripheral device for a television set having a first interface at which the television signal can be tapped off, the peripheral comprising a plug-in device or wireless communication component for providing a communication link between the peripheral device to the first interface of the television set or to a corresponding second interface of a further peripheral unit connected to the television set; a processing device configured to process at least a portion of the television signal present at the first or second interface of the peripheral device; and a transmission device configured to transmit data supplied by the processing device to a receiver device.

13. The remote control device of claim 12, wherein the processing device extracts impressed additional data in addition to the program signal from the television signal and conditions the impressed additional data for transmission.

14. The remote control device of claim 12 wherein the processing device extracts from the television signal data having two different sets of data, individual data of the two data sets being assigned to one another, assigned data of the two data sets being transmitted to the receiver device by the transmission device, and at least initially any data of the first data set being displayed on the display device of the receiver device, the second group of data including evaluation data for evaluating data input into the receiver device by a user.
